(19) United States
(12) Patent Application Publication
(10) Pub. No.: US 2003/0015477 A1
(43) Pub. Date: Jan. 23, 2003

(54) System and method for reducing swimming pool energy consumption

(76) Inventor: Ike W. Hornsby II, Bakersfield, CA (US)

Correspondence Address: James M. Duncan, Klein,DeNatale,Goldner,Cooper,Rosenlieb&Kimball, P.O. Box 11172, Bakersfield, CA, 93389-1172, US

(21) Appl. No.: 09/909,491

(22) Filed: Jul. 19, 2001

(51) Int. Cl. B01D 35/14

(52) U.S. Cl. 210/739; 210/138; 210/141; 210/143; 210/169; 210/416.2

(57) ABSTRACT

A system and method for reducing the energy consumption of a swimming pool cleaning system is disclosed. The system isolates and selectively operates the skimmer for a first predetermined time period inputted into a programmable controller. At the conclusion of this time period, the programmable controller activates an actuator which causes a diverter valve to isolate and selectively operate a suction vacuum for a second predetermined time period. Isolating and selectively operating the skimmer from the suction vacuum allows the centrifugal pump to be driven by a motor in low speed mode to be used all of the time for skimming and cleaning operations, thereby greatly reducing energy consumption. A similar system is disclosed for isolating and selectively operating a pressure cleaner. Methods for employing both systems are disclosed.

### BACKGROUND OF THE INVENTION

The present invention relates to a system and method for filtering swimming pool water and cleaning a swimming pool. More particularly, this invention relates to a system and method which reduces energy consumption by selective application of the filter pump motor to either skimming operations or vacuuming operations. The selective application of the motor to these operations one at a time allows almost continuous use of a lower speed motor resulting in substantial decreases in energy consumption.

It is known that operating a swimming pool can require a substantial amount of energy. The typical residential swimming pool installation has a filtering unit through which daily flows the total volume of water in the pool. The filtering unit is normally operated for several hours per day and is used in conjunction with chemical treatment, such as chlorination, to maintain the clarity and cleanliness of the water. Water is drawn into the filtering unit and pumped through the filtering unit with a self-priming, single suction, centrifugal type pump. A pump motor is attached directly to the seal plate of the pump. The pump motor is an open-drip proof type, capacitor start/induction run design or capacitor start/capacitor run design. Perhaps the most commonly used motor is a single phase, 60 HZ, 3450 RPM motor operating on either a 115 VAC or 230 VAC circuit.

Water may be drawn into the pump inlet from several sources. The water may come from the pool skimmer, which cleans floating debris from the surface of the water. The water may also come from a submerged drain in either the pool or a spa. The water may also come from a suction vacuum which, powered by water drawn through the unit from the pump suction, travels over the submerged surfaces of the swimming pool and collects debris such as leaves, dirt, and twigs which may accumulate at the bottom and side walls of the pool. The larger debris collected by the suction vacuum, including leaves and twigs, are typically accumulated in an in-line collection basket upstream of the pump suction. Suspended debris, such as suspended dirt and silt, is collected in the filtering medium of the filtering unit. Another type of automatic vacuuming device, the pressure cleaner, may also be used instead of the suction vacuum. The pressure cleaner is connected to a return line from the filtering unit. The pressure vacuum is powered by positive pressure, drawing debris into a filter bag by venturi action. In older installations the pressure cleaner may employ a booster pump driven by a second motor to provide the necessary pump pressure to drive the device.

It has long been recognized that energy consumption by swimming pools can be substantial and efforts have been made to develop equipment and procedures which increase the efficiency of the pool cleaning system and decrease the required energy demand. In this regard, U.S. Pat. No. 4,545,906 discloses a pump motor having two sets of stator windings allowing the motor to run at nominal running speeds of either 3500 RPM or 1750 RPM. The '906 patent discloses that for one installation, the nominal motor speed of 3500 RPM produces a flow rate of 45 gallons per minute with energy consumption of 1080 watts, while the nominal motor speed of 1750 RPM produces a flow rate of 21 gallons per minute with energy consumption of 200 watts. Thus, for the system analyzed, the lower running speed resulted in a flow rate approximately half of the flow rate at the higher speed, but the energy consumption for the lower running speed was only one-fifth of the energy consumption for the higher speed. These results show that substantial energy can be saved if the centrifugal pump can be operated at a reduced pump motor speed.

The invention disclosed in the '906 patent contemplates using the motor at both the high speed and low speed depending upon the needs of the system. For example, the patent discloses that the high motor speed is required for system priming, periods of heavy pool use or for clean-up after a storm and, of particular relevance to the system and method disclosed herein, for high speed circulation rates required for vacuuming operations. The low speed, discloses the patent, is sufficient during other times to prevent the pool from becoming stagnant with the resulting growth of algae. The speeds on the device may be manually selected. Optionally, a timer may be used to automatically switch the motor speed for predetermined periods of operation.

However, because an automatic suction vacuum is typically run several hours a day, the system disclosed in the '906 patent continues to have substantial periods of time each day during which the high speed function of the two-speed motor is required, resulting in substantial energy consumption. Many other systems, because of the added expense of the two-speed motor and second timer required by the system disclosed in the '906 patent, continue to operate entirely on high speed motors. Therefore, notwithstanding the potential energy savings available with a low speed motor, existing swimming pool systems continue to consume substantial amounts of energy. However, the disclosed system and method provide a means for running a swimming pool cleaning system with a low speed motor during almost all periods of operation.

### SUMMARY OF THE INVENTION

The present invention is directed to a system and method for reducing swimming pool energy consumption, meeting the needs identified above.

The disclosed system comprises a filter system for cleaning a swimming pool, the pool having walls and water contained within the walls, the filter system being of the type in which a water circulation path is provided, the path including the pump suction inlet from the pool, an outlet for discharging water into the pool, a centrifugal pump, and a filter between the inlet and outlet. The inlet has a first source and a second source, the first source comprising a skimmer for receiving water and debris skimmed from the surface of the water of the pool. The second source comprises a suction vacuum for receiving water and debris from the walls of the pool. The system further comprises valve means for switching the inlet from the first source to the second source and from the second source back to the first source. Actuating means are coupled to the valve means, the actuating means having a first and second position. In the first position, the actuating means manipulates the valve means to receive water from the first source. In the second position the actuating means manipulates the valve means to receive water from the second source. The system further comprises programmable input means for controlling the actuating means. A motor is coupled to the centrifugal pump, the motor having a running speed of less than 3450 revolutions per minute. A motor having a rated speed of 1725 revolutions per minute may also be used.

In another embodiment, the system comprises the same filter system for cleaning a swimming pool as in the above embodiment. However in this embodiment the outlet has a first discharge and a second discharge, the first discharge comprising a return line or return lines to the pool and the second discharge comprising a pressure cleaner for cleaning debris from the walls of the pool. The system further comprises valve means for switching the outlet from the first discharge to the second discharge and from the second discharge to the first discharge. Actuating means and programmable input means are used in the same manner as described above for the first embodiment. As with the first embodiment, a motor is coupled to the centrifugal pump, the motor having a running speed of less than 3450 revolutions per minute. A motor having a rated speed of 1725 revolutions per minute may also be used.

Methods of reducing swimming pool energy consumption are also disclosed. The first method comprises utilizing the first embodiment of the disclosed system. The second method comprises utilizing the second embodiment of the disclosed system. These and other features, aspects, and advantages of the present invention will become better understood with regard to the following description, appended claims, and accompanying drawings.

### BRIEF DESCRIPTION OF THE DRAWINGS

FIG. 1 is a diagram showing the disclosed system for use with a suction vacuum.

FIG. 2 is a diagram showing an alternative embodiment of the disclosed system for use with a suction vacuum.

FIG. 3 is a diagram showing the disclosed system for use with a pressure cleaner.

FIG. 4 is a diagram showing an alternative embodiment of the disclosed system for use with a pressure cleaner.

### DETAILED DESCRIPTION OF THE EMBODIMENTS

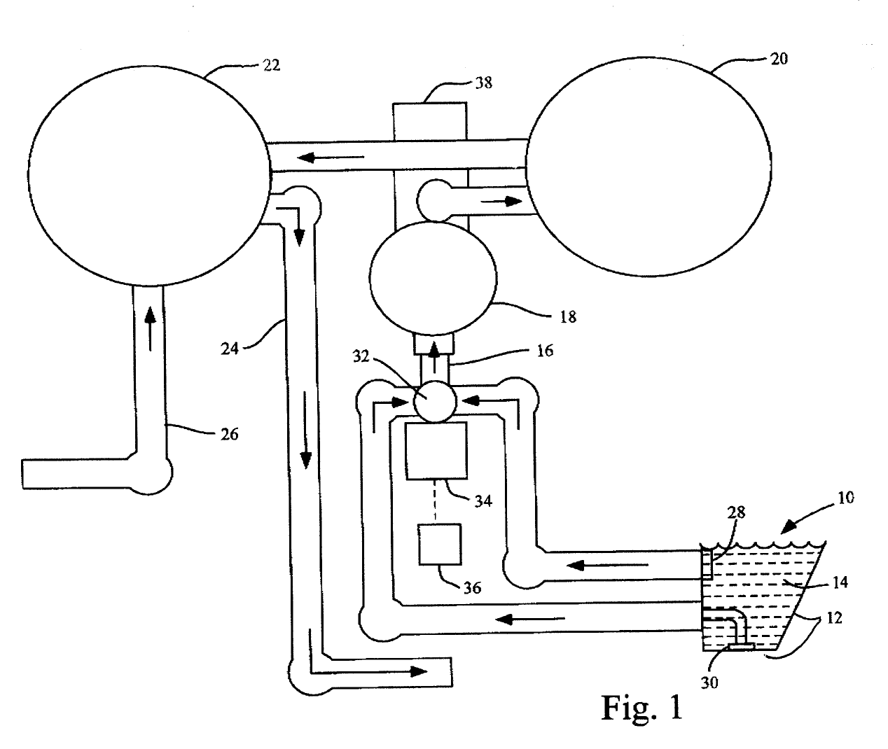

Referring now specifically to the drawings, FIG. 1 shows a diagram of the disclosed system for use with a suction vacuum system. The schematic shows a pool 10 having walls 12 and water 14 contained within the walls. The filtering system provides a water circulation path in which water 14 is taken from the pool. The path including an inlet 16 to the suction side of a single-stage centrifugal pump 18, which pumps water taken from the pool into a filtering unit 20. Filtered water exits the filtering unit 20, and may enter a heater 22 and exit the heater into a return line 24 to the pool. If heater 22 is used, heating fuel is provided to the heater through fuel line 26. Alternatively, heater 22 may be bypassed and filtered water may enter the return line 24 directly from the filtering unit 20.

The inlet 16 has two different sources from which it may receive water 14 from the pool 10. The first source is from the skimmer 28. The second source is from suction vacuum 30. Skimmer 28 includes a well which extends several inches below the surface of water 14, and typically contains a basket for collecting leaves, sticks and other debris floating on the surface of the water 14. It is to be appreciated that many pools also have a drain typically located at the bottom of the pool 10, the drain connected to a suction line common with the skimmer 28, so the term skimmer 28 used herein may also include such a drain. Alternatively, if the drain were operated on an independent line from the skimmer 28, the drain would be a third source to inlet 16. A three-way diverter valve could then be used, which would isolate each source to the inlet 16. Suction vacuum 30 operates off of suction from pump 18, and collects leaves, sticks, dirt, silt and other debris which sink and/or coat the walls 12 of the pool. Such suction vacuums are manufactured by, among others, Polaris Pool Systems, Inc. of Vista, Calif., and have been described in U.S. Pat. Nos. 3,803,658; 4,023,227; 4,133,068; 4,208,752; 4,351,077; 4,642,833; 4,742,593; 4,761,848; 4,769,867; 4,807,318; 5,265,297; 5,315,728; 5,450,645; 5,634,229 and 6,112,354.

Valve means 32, such as a diverter valve are located upstream of inlet 16 for switching from skimmer 28 to the suction vacuum 30. An acceptable diverter valve for the valve means 32 is a Jandy Never Lube Valve, Model No. 4715. Actuating means 34 are directly coupled to the valve means 32. An acceptable actuator for the actuating means 34 is an Autospa Valve Actuator, Model #VA-100E, manufactured by Chardonnay Corporation of Newport Beach, Calif. The actuating means 34 operates valve means 32 so that the source of water to inlet 16 is either the skimmer 28 or the suction vacuum 30. The actuating means 34 is controlled by programmable input means 36, which may be a simple timer, such as a Model #T104R manufactured by Intermatic Timer or a programmable digital device. The programmable input means 36 is in addition to the timer or controller used for activating the motor 38. If a three-way diverter valve is used as discussed above, the Model #VA-100E actuator or other appropriate actuating means may be modified to position the valve to allow flow from the desired source.

A motor 38 is coupled to pump 18. In order to realize reduced energy consumption from a system which uses a motor with a speed of 3450 RPM, a motor capable of running at a lower speed must be utilized. Acceptable motors for use as motor 38 are manufactured by A. O. Smith Corporation, distributed by Sta-Rite Industries of Waterford, Wis., and have dual speed capability with speeds of 3450 RPM and 1725 RPM. The most efficient types of motors are capacitor start/capacitor run design. The disclosed system greatly reduces the amount of energy consumed in operating the pool cleaning system. Existing pool cleaning systems simultaneously pull suction on both a skimmer (or drain) and a suction vacuum. As recognized in U.S. Pat. No. 4,545,906, the higher motor speed is required to simultaneously operate a skimmer and a suction cleaning system. In order to completely clean the surface area of the pool walls, it is necessary to run the suction vacuum several hours per day, greatly reducing the amount of time when the system may be operated at the lower motor speed. However, the disclosed system overcomes this limitation by isolating and selectively operating the skimmer and the suction vacuum. If these devices are isolated and run independently of one another, it is possible to utilize a lower running speed almost all of the time the pump is running, resulting in substantial energy reduction.

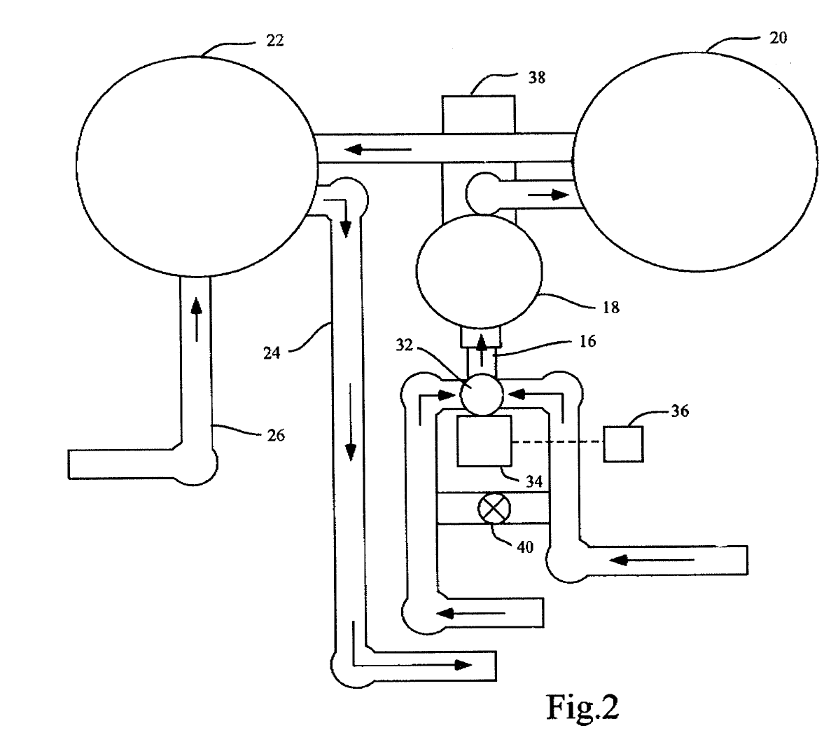

Depending upon the suction requirements of suction vacuum 30, it may be desirable, while motor 38 is running at a lower speed, to allow partial suction of the skimmer 28 at the same time suction vacuum 30 is in operation. As shown in FIG. 2, use of bypass valve 40 allows some water 14 from skimmer 28 to enter inlet 16 while suction vacuum 30 is in operation.

A method of reducing swimming pool energy consumption comprises the steps of placing the above system into operation. A pool filtering system is configured so that the pump inlet 16 may receive pool water 14 and floating debris from a first source at the skimmer 28 (or drain) or from a second source at a suction vacuum 30. The next step is to switch inlet 16 from receiving water 14 from the first source at the skimmer 28 so that inlet 16 receives water 14 from the second source at the suction vacuum 30 by using valve means 32. Valve means 32 is switched by actuating means 34 which is directly coupled to the valve means. The actuating means 34 has a first and second position, where the first position sets the valve means 32 so that inlet 16 receives water from the skimmer 28 and the second position sets the valve means so that inlet 16 receives water from the suction vacuum 30. The next step is to control actuating means 34 with programmable input means 36, so that the inlet 16 is switched from the skimmer 28 to the suction vacuum 30 for a time period entered into the programmable input means 36. At the end of this time period, the programmable input means 36 causes the actuating means 34 to manipulate valve means 32 so that inlet 16 receives water once again from the skimmer 28. The final step is drive centrifugal pump 18 with a motor 38 coupled to the pump, where the motor has a running speed of less than 3450 RPM, and preferably 1725 RPM.

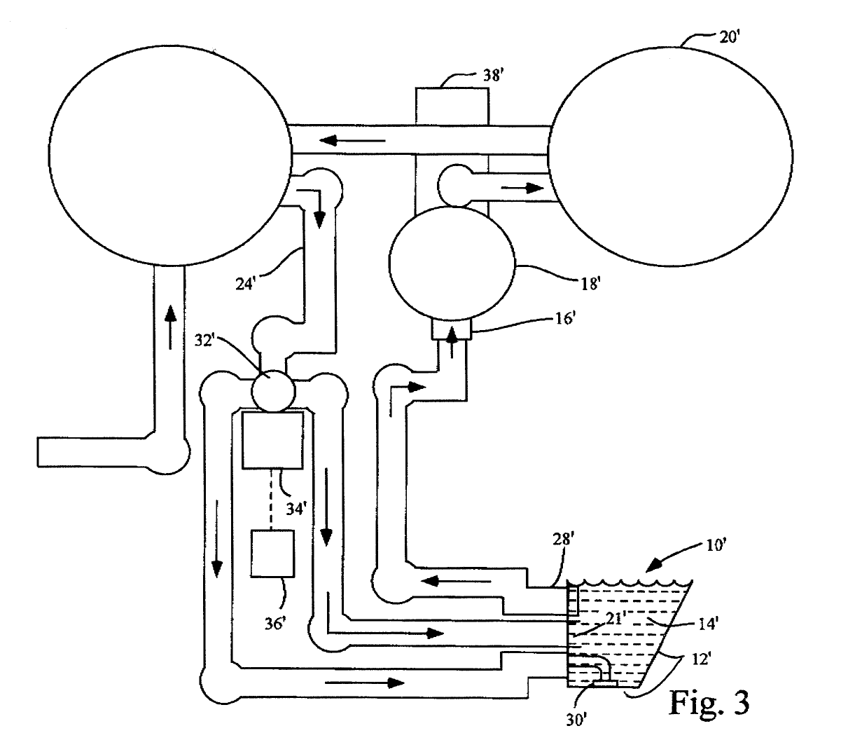

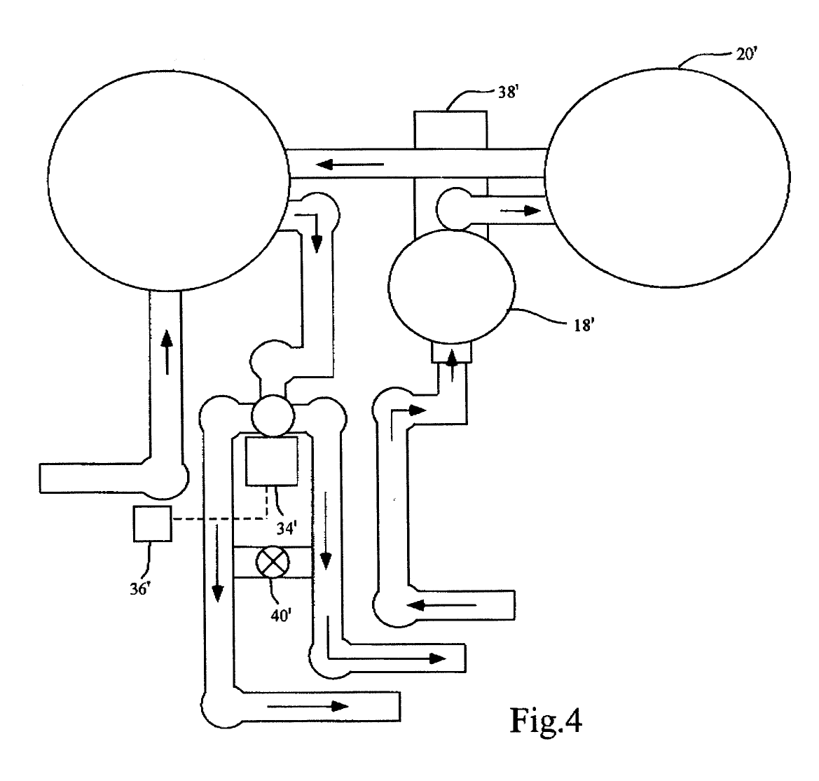

FIG. 3 and FIG. 4 disclose an embodiment of the disclosed system for use with a pressure cleaner system, in which the cleaner is connected to the return or pressure side of the filtration system for receiving positive pressure. Examples of this type of cleaner are disclosed in U.S. Pat. Nos. 3,882,574; 4,558,479; 4,589,986; and 4,734,954.

In this embodiment, the inlet 16′ receives water 14′ from a skimmer 28′ (or drain). The pump 18′ pumps the water through filter 20′. Water from the filter 20′ is discharged to an outlet 24′. Outlet 24′ has two different discharge points to which it may discharge water from the filter 20′. The first discharge point is return line 21′ which discharges directly to the pool 10′. The second discharge point is pressure cleaner 30′. In addition, other discharge points, such as a waterfall, fountain or other water feature, could be connected to outlet 24′, and flow directed to the other discharge points by either a three-way diverter valve or a two-way diverter valve installed on return line 21′.

Valve means 32′, such as a diverter valve, switches the discharge point for outlet 24′ from the return line 21′ to the pressure cleaner 30′. An acceptable diverter valve for the valve means 32′ is a Jandy Never Lube Valve, Model No. 4715. Actuating means 34′ is coupled to valve means 32′. Programmable input means 40′ are used for controlling the actuating means 34′. Motor 38′ is coupled to pump 18′. The same motor used in the embodiment shown in FIG. 1 may be used in this embodiment. It is to be appreciated that instead of directing water to return line 21′, other options may also be used, such as directing the discharge water to an ornamental waterfall, fountain, or other feature, in which case the discharge water may be diverted by additional valving means, which may be operated manually or by actuating means similar to those disclosed herein.

A second method of reducing swimming pool energy consumption comprises the steps of placing the above embodiment into operation. A pool filtering system is configured so that the pump inlet 16′ may receive pool water 14′ and floating debris from the skimmer 28′ (or drain). An outlet 24′ is configured to discharge water to a first discharge or to a second discharge, the first discharge comprising a return line 21′ to the pool 10′ and the second discharge comprising a pressure cleaner 30′ for cleaning debris from the walls 12′ of the pool 10′. Valve means 32′ are employed to switch the outlet 24′ from the return line 21′ to the pressure cleaner 30′, the valve means 32′ being switched by actuating means 34′ directly coupled to the valve means 32′. The actuating means 34′ have a first and second position, the first position manipulating the valve means 32′ to discharge water to the return line 21′ and the second position maipulating the valve means 32′ to discharge water to the pressure cleaner 30′. The actuating means 34′ are controlled with programmable input means 36′, so that the outlet 24′ is switched from the return line 21′ to the pressure cleaner 30′ for a time period entered into the programmable input means 36′ and following the inputted time period the outlet 24′ is switched back from the pressure cleaner 30′ to the return line 21′. The final step is drive centrifugal pump 18′ with a motor 38′ coupled to the pump, where the motor has a running speed of less than 3450 RPM, and preferably 1725 RPM. The valve means 32′, actuating means 34′ and programmable input means 36′ are the same as described above.

It is also to be appreciated that many pools include spas which are maintained by the same filtering system. Spas typically employ high pressure jets which require either an independent motor and booster pump, or require the centrifugal pump 18 connected to the filtering unit 20 be driven at a higher speed. The two-speed motor described above may be used for this purpose, the higher speed available by manual control.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A system for reducing swimming pool energy consumption comprising:
(a) a filter system for cleaning a pool, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) the inlet having a first source and a second source, the first source comprising a skimmer for receiving water and debris skimmed from the surface of the water and the second source comprising a suction vacuum for receiving water and debris from the walls of the pool;
(c) valve means for switching the inlet from the first source to the second source and from the second source to the first source;
(d) actuating means coupled to said valve means, the actuating means having a first and second position, the first position manipulating the valve means to receive water from the first source and the second position manipulating the valve means to receive water from the second source;
(e) programmable input means for controlling the actuating means; and
(f) a motor coupled to the centrifugal pump, the motor having a speed of less than 3450 revolutions per minute.

2. The system of claim 1 wherein the motor has a speed of 1725 revolutions per minute.

3. The system of claim 1 wherein the valve means is a diverter valve.

4. The system of claim 1 wherein a bypass valve is connected between the first source and second source.

5. The system of claim 1 wherein the programmable input means is a timer of the variety which energizes an electrical circuit for a preset time period each day.

6. The system of claim 5 wherein the timer causes the actuating means to switch from the first position to the second position.

7. A system for reducing swimming pool energy consumption comprising:
(a) a filter system for cleaning a pool, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) the outlet having a first discharge and a second discharge, the first discharge comprising a return line to the pool and the second discharge comprising a pressure cleaner for cleaning debris from the walls of the pool;
(c) valve means for switching the outlet from the first discharge to the second discharge and from the second discharge to the first discharge;
(d) actuating means coupled to said valve means, the actuating means having a first and second position, the first position manipulating the valve means to direct water to the first discharge and the second position manipulating the valve means to discharge water to the second discharge;
(e) programmable input means for controlling the actuating means; and
(f) a motor coupled to the centrifugal pump, the motor having a speed of less than 3450 revolutions per minute.

8. The system of claim 7 wherein the motor has a speed of 1725 revolutions per minute.

9. The system of claim 7 wherein the valve means is a diverter valve.

10. The system of claim 7 wherein a bypass valve is connected between the first discharge and the second discharge.

11. The system of claim 7 wherein the programmable input means is a timer of the variety which energizes an electrical circuit for a preset time period each day.

12. The system of claim 11 wherein the timer causes the actuating means to switch from the first position to the second position.

13. A method of reducing swimming pool energy consumption comprising the steps of:
(a) cleaning water from a pool with a filter system, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) configuring the inlet to receive water from a first source or a second source, the first source comprising a skimmer for taking water and debris skimmed from the surface of the water and the second source comprising a suction cleaner for taking water and debris from the walls of the pool;
(c) switching the inlet from the first source to the second source using valve means, said valve means being switched by actuating means coupled to the valve means, the actuating means having a first and second position, the first position setting the valve means to receive water from the first source and the second position setting the valve means to receive water from the second source;
(d) controlling the actuating means with programmable input means, so that the inlet is switched from the first source to the second source for a time period entered into the programmable input means and following said time period the inlet is switched from the second source to the first source; and
(e) driving the centrifugal pump with a motor coupled to the centrifugal pump, the motor having a speed of less than 3450 revolutions per minute.

14. The method of claim 13, the motor having a speed of 1725 revolutions per minute.

15. A method of reducing swimming pool energy consumption comprising the steps of:
(a) disposing water from a pool into a filter system, the pool having walls and water contained within the walls, said filter system being of the type wherein a water circulation path is provided, the path including an inlet from the pool, an outlet for discharging water into the pool, a centrifugal pump, and a filter between the inlet and outlet;
(b) configuring the outlet to discharge water to a first discharge or to a second discharge, the first discharge comprising a return line to the pool and the second discharge comprising a pressure cleaner for cleaning debris from the walls of the pool;
(c) switching the outlet from the first discharge to the second discharge using valve means, said valve means being switched by actuating means coupled to the valve means, the actuating means having a first and second position, the first position setting the valve means to discharge water to the first discharge and the second position setting the valve means to discharge water to the second discharge;
(d) controlling the actuating means with programmable input means, so that the outlet is switched from the first discharge to the second discharge for a time period entered into the programmable input means and following said time period the outlet is switched from the second discharge to the first discharge; and
(e) driving the centrifugal pump with a motor coupled to the centrifugal pump, the motor having a speed of less than 3450 revolutions per minute.

16. The method of claim 15, the motor having a speed of 1725 revolutions per minute.
